(19) United States
(12) Patent Application Publication
(10) Pub. No.: US 2023/0077413 A1
(43) Pub. Date: Mar. 16, 2023

(54) ONBOARDING OF DEVICES TO DIFFERENT WIRELESS NETWORKS

(71) Applicant: ARRIS Enterprises LLC, Suwanee, GA (US)

(72) Inventors: Xiangzhong JIAO, Shenzhen, Guangdon (CN); Feng ZHENG, Shenzhen, Guangdong (CN); Shenghao ZHANG, Shenzhen, Guangdong (CN); Yonghui WU, Shenzhen, Guangdong (CN); Shukai YANG, Shenzhen, Guangdong (CN); Fangli LIAO, Shenzhen, Guangdong (CN); Peng TAO, Shenzhen, Guangdong (CN)

(21) Appl. No.: 17/799,779

(22) PCT Filed: Feb. 18, 2020
(86) PCT No.: PCT/CN2020/075661

§ 371 Date: Aug. 15, 2022

(51) Int. Cl. H04W 48/20; H04W 76/10; H04B 17/318

(52) U.S. Cl. CPC H04W 48/20; H04W 76/10; H04B 17/318

(57) ABSTRACT

Onboarding one or more wireless devices to different wireless networks in a wireless system. A gateway/access point apparatus selects from a user interface a trigger service set identifier (SSID) among a plurality of available onboarding trigger SSIDs, each onboarding trigger SSID corresponding to a different wireless network. The gateway/access point apparatus transmits the onboarding trigger SSID to a wireless device, initiates an onboarding procedure between the wireless device and the gateway/access point apparatus, and establish a network connection between the wireless device and a wireless network based on the onboarding procedure, the wireless network corresponding to the transmitted onboarding trigger SSID. The selecting, the transmitting, the initiating, and the establishing are performed for each of the one or more wireless devices for establishing a network connection to a different one of the one or more wireless networks using a corresponding onboarding trigger SSID.

### TECHNICAL FIELD

The subject matter of the present disclosure relates generally to the onboarding of a wireless device to a wireless network using a gateway/access point apparatus.

### BACKGROUND

Wireless networks for providing services to client devices or end devices via a gateway/access point apparatus are prevalent in many homes and businesses. However, connecting or onboarding (i.e., provisioning) of a new wireless device to a wireless network can be inconvenient because it requires background knowledge of the wireless devices and the ability to properly configure and securely associate the wireless device with the network settings (e.g., service set identifier (SSID)/security code/password) of the wireless network.

There have been advances in the connecting or onboarding of a new wireless device to a wireless network. For example, a user can implement a wireless protected setup (WPS) procedure. Using WPS, a user physically pushes a WPS button on the new wireless device and a WPS button on the gateway/access point apparatus, and the WPS-enabled devices utilize a standard WPS protocol to have the gateway/access point apparatus connect or onboard the new wireless device to a wireless network.

An advantage of using WPS is that a user does not need to know the SSID and security code or password when connecting WPS-enabled devices to the wireless network. However, WPS is generally implemented to connect or onboard a wireless device to a private network. On the other hand, some wireless networks include a gateway/access point apparatus that is capable of providing connections to different wireless networks (e.g., a guest network, a backhaul network, a private network, iControl network, etc.). Moreover, each different wireless network requires a different network setting (e.g., SSID/security mode/password), which can be difficult for a user to remember and requires the ability to properly configure and securely associate a wireless device with each of the different network settings.

Therefore, using standard WPS for connecting or onboarding a wireless device to a wireless network has drawbacks. Standard WPS is only useful for connecting or onboarding one device at a time and only for onboarding to a private network. There are also security concerns associated with standard WPS. If the gateway/access point apparatus is not kept in a secure environment, someone can get access to the WPS button and gain unauthorized access to a wireless network.

Thus, it would be advantageous and an improvement over the relevant technology to provide an apparatus, system, method, and computer-readable recording medium capable of onboarding one or more wireless devices to different wireless networks while avoiding the drawbacks of standard WPS.

### SUMMARY

An embodiment of the present disclosure provides a method for onboarding one or more wireless devices in a wireless system that includes selecting from a user interface of the gateway/access point apparatus, a trigger service set identifier (SSID) among a plurality of available onboarding trigger SSIDs, and transmitting from the gateway/access point apparatus, the onboarding trigger SSID to a wireless device among the one or more wireless devices. Each of the trigger SSIDs corresponds to a different wireless network among one or more wireless networks in the wireless system.

The method includes initiating between the wireless device and the gateway/access point apparatus, an onboarding procedure using an onboarding protocol based on the transmitted onboarding trigger S SID, and establishing a network connection between the wireless device and a wireless network among the one or more wireless networks based on the onboarding procedure. The wireless network corresponds to the transmitted onboarding trigger SSID.

The selecting, the transmitting, the initiating, and the establishing performed by the method are performed for each of the one or more wireless devices for establishing a network connection to a different one of the one or more wireless networks using a corresponding onboarding trigger SSIDs selected from the user interface of the gateway/access point apparatus.

In an embodiment of the present disclosure, the method includes selecting the trigger SSID using only one physical or virtual button, wherein a different pressing sequence of the one physical or virtual button is used for triggering each of the corresponding onboarding trigger SSIDs. In another embodiment of the present disclosure, the method includes selecting the trigger SSID includes using a plurality of physical or virtual buttons, wherein each physical or virtual button is used for triggering a different one of the corresponding onboarding trigger SSIDs.

In an embodiment of the present disclosure, the method further includes initiating an open mode onboarding procedure by pressing the one or more buttons using a predetermined pressing sequence and triggering an open mode SSID, wherein the open mode onboarding procedure is performed for a predetermined period of time after being initiated.

The open mode onboarding procedure includes determining a received signal strength indicator (RSSI) from each of the one or more wireless devices, determining if the RSSI exceeds a threshold value, and establishing a network connection between a wireless network corresponding to the open mode SSID and any of the one or more devices with an RSSI level exceeding the threshold value. Additionally, the method further includes disabling one or more physical buttons when an unauthorized pressing sequence is detected, and transmitting a message regarding the disabling of the one or more physical buttons.

An embodiment described in present disclosure provides a gateway/access point apparatus for onboarding one or more wireless devices in a wireless system. The gateway/access point apparatus includes a user interface, a hardware processor, a non-transitory memory storing one or more programs, and a network interface for connecting to the one or more wireless devices.

The hardware processor executes the one or more programs to: select, using the user interface, a trigger service set identifier (SSID) among a plurality of available onboarding trigger SSIDs; transmit, using the network interface, the onboarding trigger SSID to a wireless device among the one or more wireless devices; initiate between the wireless device and the gateway/access point apparatus and using the network interface, an onboarding procedure using an on boarding protocol based on the transmitted onboarding trigger SSID; and establish a network connection between the wireless device and a wireless network among the one or more wireless networks based on the onboarding procedure.

The one or more wireless networks includes a guest network, a backhaul network, a private network, an iControl network, or an IoT network. The user interface includes one or more physical or virtual buttons for selecting the trigger SSID, and when the selecting of the trigger SSID includes using only one physical or virtual button, a different pressing sequence of the one physical or virtual button is used for triggering each of the corresponding onboarding trigger SSIDs. On the other hand, when the selecting of the trigger SSID includes using a plurality of physical or virtual buttons, each physical or virtual button is used for triggering a different one of the corresponding onboarding trigger SSIDs.

In an embodiment of the present disclosure, the one or more buttons of the user interface can be used to initiate an open mode onboarding procedure by pressing the one or more buttons using a predetermined pressing sequence and triggering an open mode SSID, wherein the open mode onboarding procedure is performed for a predetermined period of time after being initiated. In an embodiment of the present disclosure, the one or more buttons of the user interface can be disabled when an unauthorized pressing sequence is detected using the one or more buttons.

An embodiment described in the present disclosure provides a system for onboarding one or more wireless devices in a wireless system. The wireless system includes a gateway/access point apparatus including a user interface, a network interface, a hardware processor, and a non-transitory memory storing one or more programs. The system includes one or more wireless devices, each wireless device including a hardware processor, a non-transitory memory storing one or more programs, and a network interface; and one or more wireless networks. Each wireless network is configured to establish a wireless network connection with the network interface of each of the one or more wireless devices.

The respective hardware processors in the gateway/access point apparatus and the one or more wireless devices execute their respective one or more programs to cause the system to: select, using the user interface of the gateway/access point apparatus, a trigger service set identifier (SSID) among a plurality of available onboarding trigger SSIDs, transmit, using the network interface of the gateway/access point apparatus, the onboarding trigger SSID to a wireless device among the one or more wireless devices; initiate between the network interface of the wireless device and the network interface of the gateway/access point apparatus, an onboarding procedure using an onboarding protocol based on the transmitted onboarding trigger SSID; and establish a network connection between the network interface of the wireless device and a wireless network among the one or more wireless networks based on the onboarding procedure.

The one or more wireless networks includes a guest network, a backhaul network, a private network, an iControl network, or an IoT network, and the one or more wireless devices including a smartphone, tablet, digital personal assistance, hand-held wireless device, iControl device, or IoT device.

An embodiment described in the present disclosure provides a non-transitory computer-readable recording medium in a gateway/access point apparatus for onboarding one or more wireless devices in a wireless system, the wireless system including one or more wireless networks, the gateway/access point apparatus and the one or more wireless devices. The non-transitory computer-readable recording medium stores one or more programs which when executed by the hardware processor performs the steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system for onboarding of wireless devices to different wireless networks according to an embodiment of the present disclosure;

FIG. 2 is a more detailed schematic diagram of a system for onboarding of wireless devices to different wireless networks according to an embodiment of the present disclosure;

FIG. 3 illustrates is a more detailed schematic diagram of a gateway/access point apparatus, client device, and mobile device in the system for onboarding of wireless devices to different wireless networks according to an embodiment of the present disclosure;

FIG. 4A is a user interface of a gateway/access point apparatus according to an embodiment of the present disclosure;

FIG. 4B is a user interface of a gateway/access point apparatus according to an embodiment of the present disclosure;

FIG. 5 illustrates a method and algorithm for performing onboarding of wireless devices in a wireless network according to an embodiment of the present disclosure;

FIG. 6 illustrates a method and algorithm for performing an open mode onboarding of wireless devices in a wireless network according to an embodiment of the present disclosure; and

FIG. 7 illustrates a method and algorithm for providing a protection function for a wireless network according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

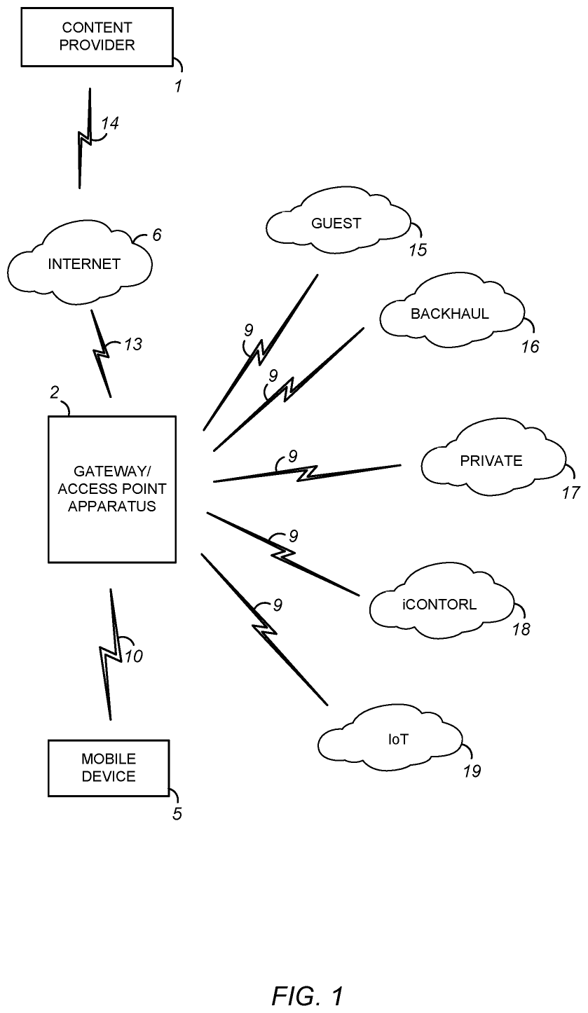

FIG. 1 is a schematic diagram of a system for onboarding different wireless devices to different wireless networks according to an embodiment of the present disclosure. As shown in FIG. 1, the system includes a gateway/access point apparatus 2 connected to a content provider 1 via an Internet 6 and also connected to different wireless networks such as a guest network 15, a backhaul network 16, a private network 17, an iControl network 18 and an Internet of Things (IoT) network 19. As shown in FIG. 1, the gateway/access point apparatus 2 is also connected to a mobile device 5.

Starting from the top of FIG. 1, the content provider 1 may be a cable television provider, a satellite television provider, an internet service provider, or multiple system operators. The connection 14 between the Internet 6 and the content provider 1 can be implemented using a wide area network (WAN), a virtual private network (VPN), metropolitan area networks (MANs), system area networks (SANs), a public switched telephone network (PTSA), a global Telex network, or a 2G, 3G, 4G or 5G network. The connection 13 between the gateway/access point apparatus 2 and the Internet 6 can be implemented using a digital subscriber line (DSL) connection, cable modem, a broadband mobile phone network, an optical network, or other similar connections. The connection 13 can also be implemented using a wireless connection that operates in accordance with, but is not limited to, IEEE 802.11 protocol, a Radio Frequency For Consumer Electronics (RF4CE) protocol, ZigBee protocol, Z-Wave protocol, or IEEE 802.15.4 protocol. It is also contemplated by the present disclosure that connection 13 is capable of providing connections between the gateway/access point apparatus 2 and a WAN, a LAN, a VPN, MANs, PANs, WLANs, SANs, a PTSA, a global Telex network, or a 2G, 3G, 4G or 5G network.

The gateway/access point apparatus 2 is a hardware electronic device that acts as a router for providing content received from the content provider 1 to network devices (e.g., client devices, wireless extenders, or mobile device) in one of more wireless networks 15-19. It is also contemplated by the present disclosure that the gateway/access point apparatus 2 can be, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

The connection 9 between the gateway/access point apparatus 2 and the wireless networks 15-19 can be implemented using a wireless connection in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the connection 9 can be implemented using a wireless connection that operates in accordance with, but is not limited to, IEEE 802.11 protocol, RF4CE protocol, ZigBee protocol, Z-Wave protocol, or IEEE 802.15.4 protocol. It is also contemplated by the present disclosure that the connections 9 can include connections to a media over coax (MoCA) network.

As shown in FIG. 1, each of networks 15-19 are different wireless networks connectable to the gateway/access point apparatus 2 via connection 9. Each of the different wireless networks 15-19 can have different network settings (e.g., service set identifier (SSID)/security key/password). The guest network 15 can be a network that offers Wi-Fi Internet access to guests without compromising the security of, for example, the private network 17 and the devices on that network. The backhaul network 16 can be a wireless network that includes, for example, wireless extenders. The private network 17 can be implemented as a primary network or local network for all home devices. The iControl network can be a network that offers an iControl platform and access to iControl devices, and the IoT network 18 can be a wireless network for accessing and control of IoT devices such as appliances or other similar consumer electronic devices.

In FIG. 1, the different networks 15-19 are shown as separate wireless networks. However, it is also contemplated by the present disclosure that there could be some overlap between devices in the different networks 15-19. That is, one or more network devices could be located in more than one network 15-19. For example, wireless extenders could be located both in the private network 17 for providing content and information to a client device and also included in the backhaul network 16.

The mobile device 5 is any handheld computer, smartphone, electronic tablet, e-reader, personal digital assistant (PDA), or portable music players with smart capabilities that is capable of connecting to the Internet, cellular networks, and interconnect with other devices via Wi-Fi and Bluetooth protocols. The connection 10 between the gateway/access point apparatus 2 and the mobile device 5 is implemented through a wireless connection that operates in accordance with, but is not limited to, IEEE 802.11 protocol. The connection 10 between the gateway/access apparatus 2 and the mobile device 5 can also be implemented through a WAN, a LAN, a VPN, MANs, PANs, WLANs, SANs, a PTSA, a global Telex network, or a 2G, 3G, 4G or 5G network.

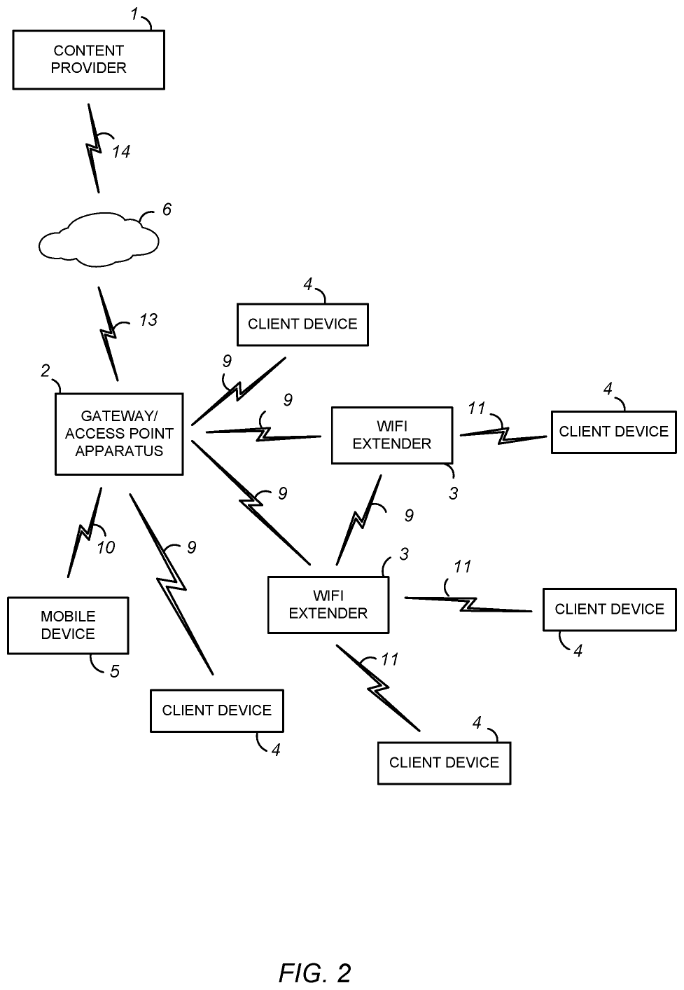

FIG. 2 is a more detailed schematic diagram of the system for onboarding of wireless devices to different wireless networks according to an embodiment of the present disclosure. The difference between FIG. 1 and FIG. 2 is that FIG. 2 shows exemplary network devices that can be included in the different networks 15-19 of FIG. 1.

For example, the guest network 15 could include one or more client devices 4 connected directly to the gateway apparatus 2 via connection 9 for gaining access to the Internet 6. The backhaul network 16 could include one or more of the wireless extenders 3. The private network could include one more client devices 4 receiving content from the content provider 1 through the gateway/access apparatus 2. One or more of the client devices 4 could also include iControl device or IoT devices that are controlled, for example, by the mobile device 5 or by another client device 4 through connection 10 to the gateway/access apparatus 2 and through a respective connection 9 to the iControl network 18 and the IoT network 19.

As shown in FIG. 2, the network devices includes client devices 4 and wireless (WiFi) extenders 3 communicating directly or indirectly with the gateway/access point apparatus 2 via respective wireless connections 9, 11. Each client device 4 includes, for example, a computer, a portable device, an electronic tablet, a smart phone, smart speakers, IoT devices, iControl devices, or other wireless hand-held consumer electronic device capable of executing and displaying the content received through, for example, the gateway/access point apparatus 2.

The wireless extenders 3 are hardware electronic devices that are used to extend the wireless network by receiving the signals transmitted by the gateway/access point apparatus 2 and rebroadcasting the signals to client devices 4, which may out of range of the gateway/access point apparatus 2. The wireless extenders 3 can also receive signals from the client devices 4 and rebroadcast the signals to the gateway/access point apparatus 2, mobile device 9, or other client devices 4.

The connection 9 between the gateway/access point apparatus 2 and the wireless extenders 3 and between the gateway/access point apparatus 2 and client devices 4 are implemented using a wireless connection that operates in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the connection 9 can be implemented using a wireless connection that operates in accordance with, but is not limited to, IEEE 802.11 protocol, RF4CE protocol, ZigBee protocol, Z-Wave protocol, or IEEE 802.15.4 protocol. It is also contemplated by the present disclosure that the connections 9 can include connections to a media over coax (MoCA) network.

The connection 11 between the wireless extenders 3 and the client devices 4 are also implemented through a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the connection 11 can be implemented using a wireless connection that operates in accordance with, but is not limited to, IEEE 802.11 protocol, RF4CE protocol, ZigBee protocol, Z-Wave protocol, or IEEE 802.15.4 protocol.

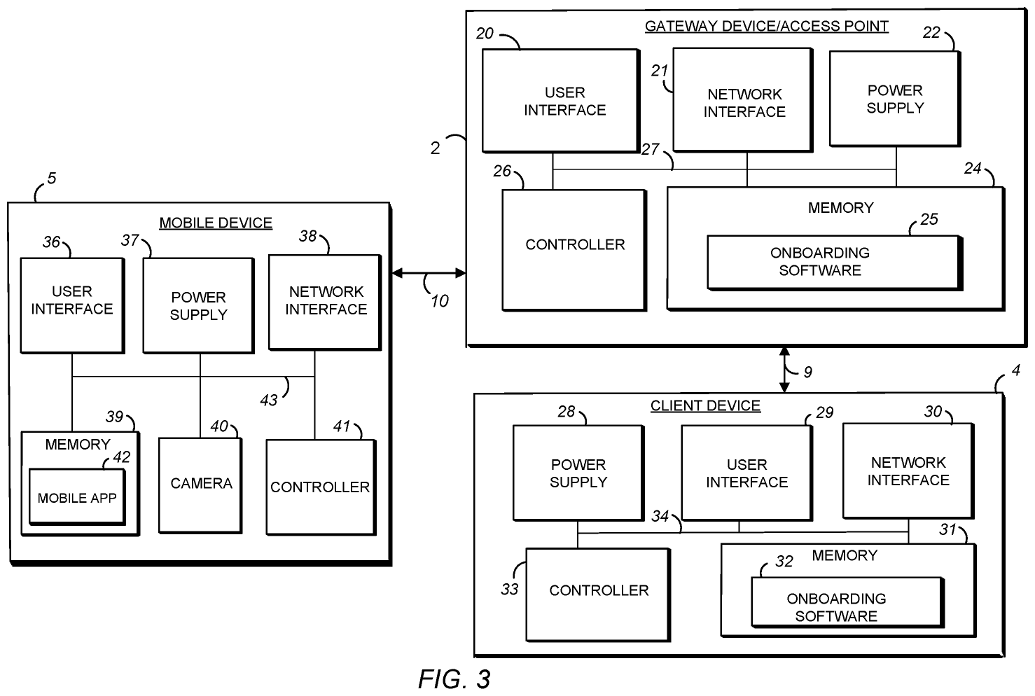

A detailed description of the exemplary internal components of the gateway/access point apparatus 2, the client device 4, and mobile device 5 shown in FIGS. 1 and 2 will be provided in the discussion of FIG. 3. However, in general, it is contemplated by the present disclosure that the gateway/access point apparatus 2, the extenders 3, the client devices 4, and the mobile device 5 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the gateway/access point apparatus 2, the extenders 3, the client device 4, and the mobile device 5 may be adapted to execute any operating system, including Linux, UNIX, Windows, MacOS, DOS, and ChromOS as well as virtual machines adapted to virtualize execution of a particular operating system, including customized and proprietary operating systems. The gateway/access point apparatus 2, the client device 4, the extenders 3, and mobile device 5 are further equipped with components to facilitate communication with other computing devices over the one or more network connections to local and wide area networks, wireless and wired networks, public and private networks, and any other communication network enabling communication in the system.

FIG. 3 illustrates is a more detailed schematic diagram of a gateway/access point apparatus 2, an exemplary client device 4, and the mobile device 5 in the system for onboarding of wireless devices to different wireless networks according to an embodiment of the present disclosure. Although FIG. 3 only shows one client device 4, the client device 4 in the figure is meant to be representative of the other client devices 4 shown in FIG. 1 and FIG. 2.

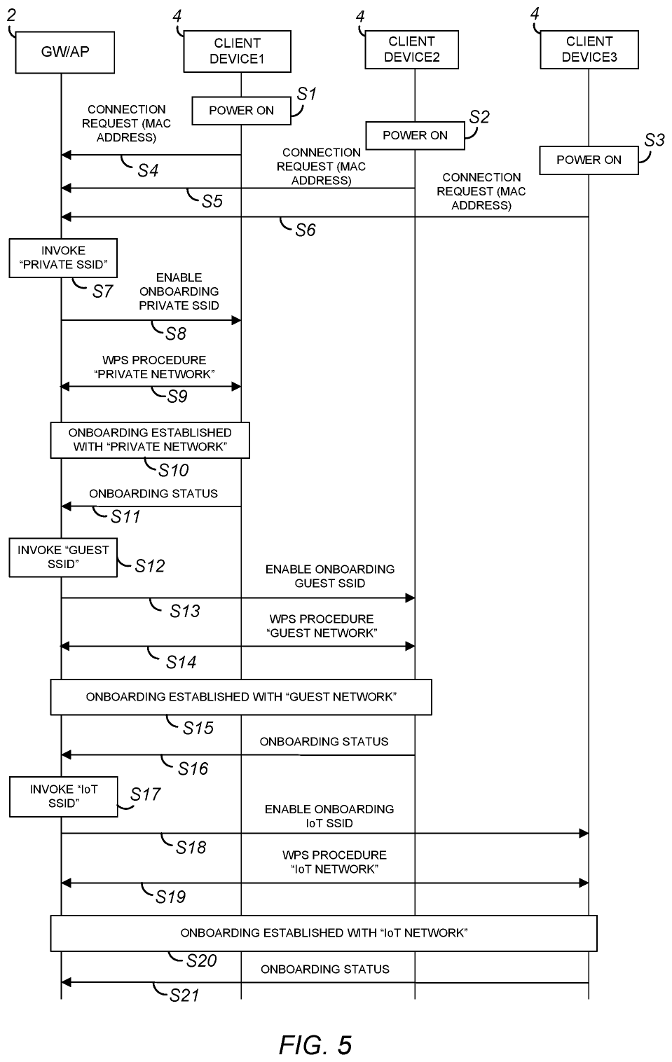

Now referring to FIG. 3 (e.g., from left to right), the mobile device 5 is any handheld computer, smartphone, electronic tablet, e-reader, personal digital assistant (PDA), or portable music players with smart capabilities that is capable of connecting to the Internet, cellular networks, and interconnect with other devices via Wi-Fi and Bluetooth. As shown in FIG. 5, the mobile device 5 includes a user interface 36, a power supply 37, a network interface 38, a memory 39, a camera 40, and a controller 41. The user interface 36 includes, but is not limited to, push buttons, a keyboard, a keypad, a liquid crystal display (LCD), cathode ray tube (CRT), thin film transistor (TFT), light-emitting diode (LED), high definition (HD) or other similar display device including a display device having touch screen capabilities so as to allow interaction between a user and the mobile device 5. The power supply 37 supplies power to the internal components of the mobile device 5 through the internal bus 43. The power supply 37 includes a self-contained power source such as a battery pack with an interface to be powered through an electrical charger connected to an outlet (e.g., either directly or by way of another device). The power supply 37 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 38 includes various network cards, interfaces, and circuitry implemented in software and/or hardware to enable communications with the gateway/access point apparatus 2 using connection 10. The various network cards, interfaces, and circuitry enable communications via connection 10 using a wireless connection that operates in accordance with, but is not limited to, IEEE 802.11 protocol. The connection 10 between the residential gateway 2 and the mobile device 5 using the network interface 38 can also be implemented through the Internet, a computer network, a WAN, a LAN, a VPN, MANs, PANs, WLANs, SANs, a PTSA, a global Telex network, or a 2G, 3G, 4G or 5G network.

The memory 39 includes a single memory or one or more memories or memory locations that include, but are not limited to, a random access memory (RAM), dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), hard disk or any other various layers of memory hierarchy.

The memory 39 can be used to store any type of instructions including onboarding software such as the onboarding mobile application 42 associated with algorithms, processes, or operations for controlling the general functions and operations of the mobile device 5 and the onboarding operations of devices to the different networks 15-19. The camera 40 is a standard camera of a camera phone that is able to capture photographs and record video.

The controller 41 controls the general operations of the mobile device 5 and includes, but is not limited to, a central processing unit (CPU), a hardware microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the mobile device 5. General communication between the components (e.g., 36-41) of the mobile device 5 is performed using the internal bus 43.

The gateway/access point apparatus 2 is a hardware electronic device that acts as a router for providing content received from the content provider 1 to the devices (e.g., client devices 4) in the wireless residential network using connection 9. It is also contemplated by the present disclosure that the gateway/access point apparatus 2 can be, but is not limited to, an IP/QAM STB or SMD that is capable of decoding audio/video content, and playing OTT or MSO provided content. As shown in FIG. 3, the gateway/access point apparatus 2 includes a user interface 20, a network interface 21, a power supply 22, a memory 24, and a controller 26.

The user interface 20 includes, but is not limited to, push buttons, a keyboard, a keypad, an LCD, a CRT, a TFT, an LED, an HD or other similar display device including a display device having touch screen capabilities so as to allow interaction between a user and the gateway/access point apparatus 2. The network interface 21 includes various network cards, and circuitry implemented in software and/or hardware to enable communications with the client devices 4 and WiFi extenders 3 using connection 9 and with the mobile device using connection 10.

The various network cards, interfaces, and circuitry of the network interface 21 enable communications via connection 9 using a wireless protocol in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the various network cards, interfaces, and circuitry of the network interface 21 enable communications via connection 9 using a wireless connection that operates in accordance with, but is not limited to, IEEE 802.11 protocol, RF4CE protocol, ZigBee protocol, Z-Wave protocol, or IEEE 802.15.4 protocol.

The various network cards, interfaces, and circuitry of the network interface 21 enable communications via connection 10 to the mobile device 5 using a wireless protocol that operates in accordance with, but is not limited to, IEEE 802.11 protocol. The connection 10 between the residential gateway 2 and the mobile device 5 using the network interface 21 can also be through the Internet, a computer network, a WAN, a LAN, a VPN, MANs, PANs, WLANs, SANs, a PTSA, a global Telex network, or a 2G, 3G, 4G or 5G network.

The power supply 22 supplies power to the internal components of the gateway/access point apparatus 2 through the internal bus 27. The power supply 22 can be a self-contained power source such as a battery pack with an interface to be powered through an electrical charger connected to an outlet (e.g., either directly or by way of another device). The power supply 22 can also include a rechargeable battery that can be detached allowing for replacement such as a NiCd, a NiMH, a Li-ion, or a Li-pol battery.

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions including onboarding software 25 associated with algorithms, processes, or operations for controlling the general functions and operations of the gateway/access point apparatus 2 for performing onboarding operations of the wireless devices to the different networks 15-19.

The controller 26 controls the general operations of the gateway/access point apparatus 2 and includes, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the gateway/access point apparatus 2. Communication between the components (e.g., 20-22, 24, and 26) of the gateway/access point apparatus 2 is established using the internal bus 27.

The client devices 4 include, for example, a computer, a portable device, an electronic tablet, a smart phone, smart speakers, IoT devices, iControl devices, or other wireless hand-held consumer electronic device capable to executing and displaying the content received through the gateway/access point apparatus 2. As shown in FIG. 3, the client device 4 includes a power supply 28, user interface 29, network interface 30, a memory 31, and a controller 33. The power supply 28 supplies power to the internal components of the client device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as NiCd, a NiMH, a Li-ion, or a Li-pol battery. The user interface 29 includes, but is not limited to, push buttons, a keyboard, a keypad, an LCD, a CRT, a TFT, an LED, an HD or other similar display device including a display device having touch screen capabilities so as to allow interaction between a user and the client device 4.

The network interface 30 includes various network cards, interfaces, and circuitry implemented in software and/or hardware to enable communications with the gateway/access point apparatus 2 via connection 9 using a wireless protocol that operates in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the various network cards, interfaces, and circuitry of the network interface 30 enable communications via connection 9 using a wireless connection that operates in accordance with, but is not limited to, IEEE 802.11 protocol, RF4CE protocol, ZigBee protocol, Z-Wave protocol, or IEEE 802.15.4 protocol. The network interface 30 also includes software and/or hardware to enable communications with the extenders 3 via connection 11 using a wireless connection that operates in accordance with a Bluetooth protocol or other short range protocols that operate in accordance with a wireless technology standard for exchanging data over short distances using short-wavelength Ultra high frequency (UHF) radio waves from 2.4 to 2.485 GHz.

The memory 31 includes a single memory or one or more memories or memory locations that include, but are not limited to a RAM, a DRAM, a memory buffer, a hard drive, a database, an EPROM, an EEPROM, a ROM, a flash memory, logic blocks of a FPGA, hard disk or any other various layers of memory hierarchy. The memory 31 can be used to store any type of instructions including onboarding software 32 associated with algorithms, processes, or operations for controlling the general functions and operations of the client device 4 and the onboarding operations of the client device onto the different networks 15-19.

The controller 33 controls the general operations of the client device 4 and includes, but is not limited to, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the client device 4. Communication between the components (e.g., 28-31 and 33) of the client device 4 is established using an internal bus 34.

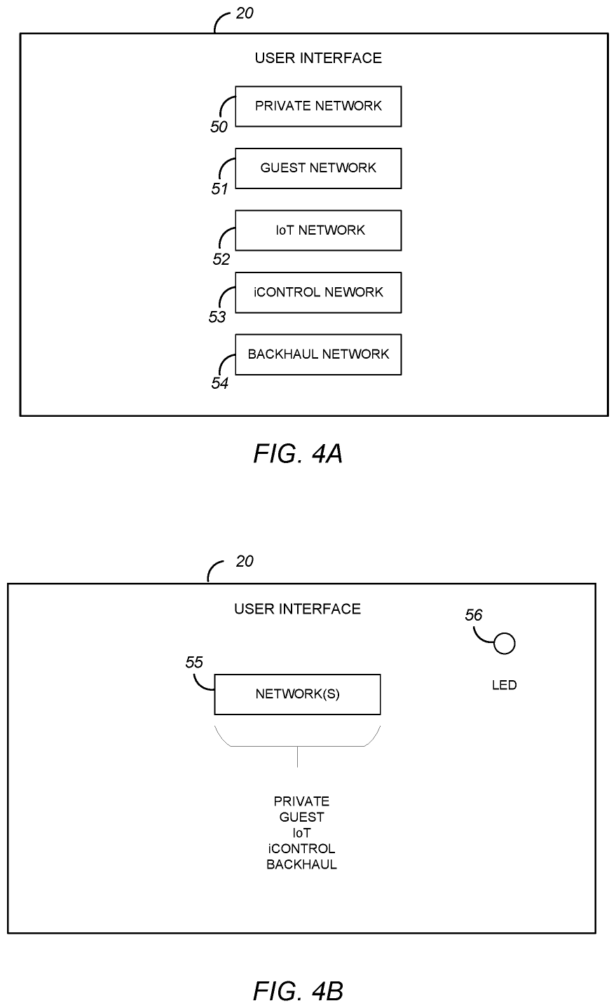

FIGS. 4A and 4B each illustrate an exemplary user interface of a gateway/access point apparatus according to an embodiment of the present disclosure.

As shown in FIG. 4A, the user interface 20 of the gateway/access point apparatus 2 includes the use of separate network buttons 50-54 for connecting a device (e.g., client device 4 or extender 3) to a respective network 15-19. The buttons include a private network button 50, a guest network button 51, an IoT network button 52, an iControl network button 53, and a backhaul network button 54. Although 4A discloses the use of five different network buttons (e.g., 50-54) for connecting a device (e.g., client device 4 or extender 3) to a respective wireless network 15-19, it is contemplated by the present disclosure that more than five network buttons can be implemented with the user interface 20 of the gateway/access point apparatus 2.

By using the different network buttons on the user interface 20 of the gateway/access point apparatus 2, devices can be connected to different networks 15-19 via connection 9. Each of the network buttons (e.g., 50-54) on the user interface 20 can be implemented using a physical or virtual button for connecting a device (e.g., client device 4 or extender 3) to a respective network 15-19, and each of networks 15-19 may have different network settings (e.g., service set identifier (SSID)/security key/password). The guest network 15 can be a network that offers Wi-Fi Internet access to guests without compromising the security of, for example, the private network 17 and the devices on that network. The backhaul network 16 can be a wireless network for wireless extenders 3. The private network 17 can be a wireless private network, primary network, or local network for all home devices. The iControl network can be a network that offers iControl platform and access to iControl devices, and the IoT network 18 can be a wireless network for accessing and control of IoT devices.

FIG. 4B illustrates another configuration of the user interface 20 of the gateway/access point apparatus 2, which, in this case, includes the use of one network button for connecting a device (e.g., client device 4 or extender 3) to a respective network 15-19. The network button 55 on the user interface 20 can be implemented using a physical or virtual button for connecting a device (e.g., client device 4 or extender 3) to a respective network 15-19. The user interface 20 of the gateway/access point apparatus 2 allows the connection of devices to different network by using multiple pressing sequences, wherein each pressing sequence may provide a connection to a different network 15-19.

For example, a user can connect a device to the private network 17 by pressing network button 55 one time, a user can connect a device to the guest network 15 by pressing network button 55 two times, and a user can connect a device to the iControl network 18 by pressing network button 3 times. Additionally, a user can connect a device to the backhaul network 16 by pressing network button 55 four times, and a user can connect a device to the IoT network 19 by pressing network button 55 five times. Additionally, it is contemplated by the disclosure that a user may connect a device to a specified Wi-Fi network by entering the corresponding network PIN or using a WPS procedure if the devices are WPS-enabled.

With the use of one network button 55, it is contemplated by the present disclosure that an object can be used to define the network a device will be connected via, for example, the use of WPS. Additionally, a new object can be added to define the network to which a device can be connected. An exemplary object is shown below. In the exemplary object, a default value is guest(2) and WPS is used to connect the device to a specified network.

Exemplary Object
Object Name: WifiNetworkEnableWPS
Value list:
   1: private(1)
   2: guest(2)
   3: iControl(3)
   4: Backhaul(4)
   5: IoT(5)
   Default values: guest(2)

In this example, by pressing and holding the network button 55 for longer than, for example, 10 seconds the object (e.g., WifiNetworkEnableWPS) can be changed. Additionally, if there is a light emitting diode (LED) 56 in the user interface, a different LED status can be used to indicate the value of the object (e.g., WifiNetworkEnableWPS). By implementing the user interface of the gateway/access point apparatus 2 (e.g., FIGS. 4A or 4B), a user doesn't need to remember any WiFi network settings and is able to connect wireless devices to different WiFi networks simply pressing the network buttons 50-55.

FIG. 5 illustrates an exemplary method and algorithm for performing onboarding (e.g., connecting) of wireless devices to different wireless networks according to an embodiment of the present disclosure. It is assumed that the wireless devices (e.g., client device 4) and the gateway/access point apparatus 2 include their respective onboarding software 25, 32 in their respective memories 24, 31. In FIG. 5, the method and algorithm illustrate operations performed between the onboarding software 25 of the gateway/access point apparatus 2 and the onboarding software 32 of three client devices 4 (e.g., client device1, client device2, and client device3) when performing onboarding to different wireless networks 15-19. The onboarding software 25, 32 in the respective memories 24, 31 can be for implementing, for example, a wireless protected setup (WPS) procedure between the client devices 4 and the gateway/access point apparatus 2 for establishing connections to the different wireless networks 15-19. Although FIG. 5 shows one gateway/access point apparatus 2 and three client devices 4 onboarding to three different wireless networks 15, 17, 19, it is contemplated by the present disclosure that the method and algorithm can be applied to any number of gateway/access point apparatuses 2 and client devices 4 for onboarding (e.g., connecting) to any number of wireless networks including all the wireless networks 15-19 described with reference to FIG. 1.

In steps S1, S2, and S3, the client devices 4 are turned on by using their respective power supplies 22, 28, 37 and in steps S4, S5, and S6 each of the client devices 4 transmits a request (e.g., including a respective MAC address) to the gateway/access point apparatus 2 for connection to a network. The request can be invoked by, for example, pressing a physical or virtual network button (e.g., WPS button) on the client user interface 29 of the client devices 4 and transmitting the request via connection 9. It is contemplated by the present disclosure that the requests for connection to the network can be transmitted from the different client devices 4 either simultaneously or sequentially, but the requests will generally be processed by the gateway/access point apparatus 2 sequentially. In step S7, the user of the gateway/access point apparatus 2 invokes the private network SSID for initiating a WPS procedure for onboarding the client device 4 (e.g., client device1 transmitting the request in step S4) to the private network 17.

The invoking of the private SSID from the gateway/access point apparatus 2 can be accomplished by using the user interface 20 shown in FIG. 4A or 4B. For example, when implementing the user interface 20 in FIG. 4A, the user would push the physical or virtual “private” button 50 among the plurality of buttons 50-54. On the other hand, when implementing the user interface 20 in FIG. 4B, the user would press the one physical or virtual button 55 using a predetermined pressing sequence assigned for invoking and initiating a WPS procedure to the private network 17. In this example, each of networks 15-19 uses a different network setting (e.g., SSID/security key/password). In step S8, the gateway/access point apparatus 2 transmits a response for enabling onboarding of the client device 4 to the private network 17 that includes, for example, an onboard-trigger SSID, which is an SSID unique to the private network 17 and which may include part or all of the MAC address or serial number of the client device 4 transmitting the request (e.g., client device1 transmitting the request in step S4).

In step S9, the gateway/access point apparatus 2 and the client device 4 perform a message exchange for implementing the WPS procedure and the onboarding of client device 4 (e.g., client device1) to the private network 17 using the onboard-trigger SSID, and in step S10, the connection between the client device (e.g., client device1) and the private network 15 is established. In step S11, the onboarded client device (e.g., client device1) transmits an onboarding status (e.g., pass or fail) back to the gateway/access point apparatus 2.

Next, in step S12, the user of the gateway/access point apparatus 2 invokes the guest network SSID for initiating a WPS procedure for onboarding a different client device 4 (e.g., client device2 transmitting the request in step S5) to the guest network 17. When using the user interface 20 in FIG. 4A, the user would push the physical or virtual “guest” button 51 among the plurality of buttons 50-54. When implementing the user interface 20 in FIG. 4B, the user would press the one physical or virtual button 55 using a predetermined pressing sequence assigned for invoking and initiating a WPS procedure to the guest network 15. In step S13, the gateway/access point apparatus 2 transmits a response for enabling onboarding of the client device 4 (e.g., client device2) to the guest network 15 that includes, for example, an onboard-trigger SSID, which is an SSID unique to the guest network 15 and which may include part or all of the MAC address or serial number of the client device 4 (e.g., client device2 transmitting the request in step S5) transmitting the request.

In step S14, the gateway/access point apparatus 2 and the client device 4 (e.g., client device2) perform a message exchange for implementing the WPS procedure and the onboarding of client device 4 (e.g., client device2) to the guest network 15 using the onboard-trigger SSID, and in step S15, the connection between the client device (e.g., client device2) and the guest network 15 is established. In step S16, the onboarded client device (e.g., client device2) transmits an onboarding status (e.g., pass or fail) back to the gateway/access point apparatus 2.

In step S17, the user of the gateway/access point apparatus 2 invokes the IoT network SSID for initiating a WPS procedure for onboarding yet another client device 4 (e.g., client device3 transmitting the request in step S6) to the IoT network 19. When implementing the user interface 20 in FIG. 4A, the user would push the physical or virtual “IoT” button 52 among the plurality of buttons 50-54. When implementing the user interface 20 in FIG. 4B, the user would press the one physical or virtual button 55 using a predetermined pressing sequence assigned for invoking and initiating a WPS procedure to the IoT network 19. In step S18, the gateway/access point apparatus 2 transmits a response for enabling onboarding of the client device 4 (e.g., client device3) to the IoT network 19 that includes, for example, an onboard-trigger SSID, which is an SSID unique to the IoT network 19 and which may include part or all of the MAC address or serial number of the client device 4 (e.g., client device3 transmitting the request in step S6) transmitting the request.

In step S19, the gateway/access point apparatus 2 and the client device 4 (e.g., client device3) perform a mutual message exchange for implementing the WPS procedure and the onboarding of client device 4 (e.g., client device3) to the IoT network 15 using the onboard-trigger SSID, and in step S20, the connection between the client device (e.g., client device3) and the IoT network 19 is established. In step S21, the onboarded client device (e.g., client device3) transmits an onboarding status (e.g., pass or fail) back to the gateway/access point apparatus 2.

In the exemplary method and algorithm of FIG. 5, the onboarding of the different client devices 4 to the different wireless networks 15-19 is performed by the user directly from the gateway/access point apparatus 2. However, it is contemplated by the present disclosure that a user of the mobile device 5 can perform the onboarding operations by using the mobile application 42 of the mobile device 5 via connection 10 to the gateway/access point apparatus 2. By using the method and algorithm of FIG. 5, a user of the gateway/access point apparatus 2 can connect any number of wireless device (e.g. client devices 4 and extenders 3) to different wireless networks 15-19.

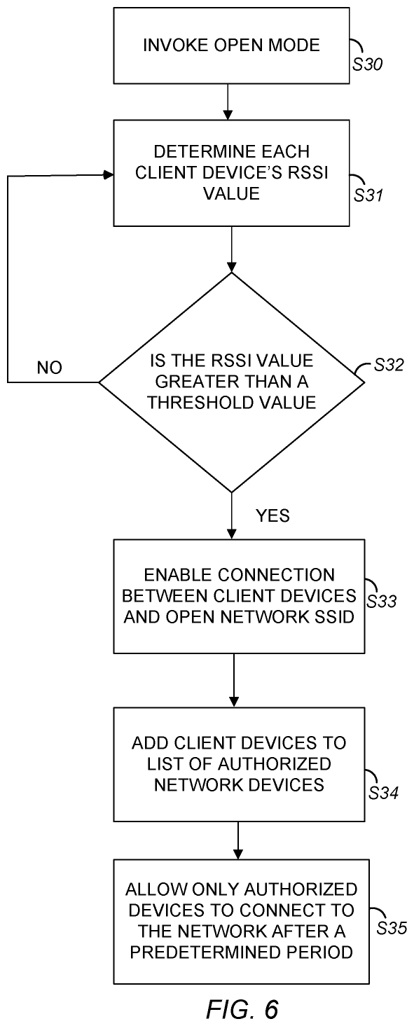

FIG. 6 illustrates a method and algorithm for performing an open mode onboarding of wireless devices to a wireless network according to an embodiment of the present disclosure. In FIG. 6, the method and algorithm illustrate operations performed between the onboarding software 25 of the gateway/access point apparatus 2 and the onboarding software 32 of three client devices 4 when performing onboarding of one or more client device to a wireless network using an open mode SSID.

In steps S30, a user of the gateway/access point apparatus 2 invokes an open mode SSID via the user interface 20 of the gateway/access point apparatus 2. The invoking of the open SSID from the gateway/access point apparatus 2 can be accomplished by using either configuration of the user interface 20 shown in FIG. 4A or 4B. For example, when implementing the user interface 20 in FIG. 4A, the user would push, for example, the physical or virtual “guest” network button 51 using a predetermined pressing sequence (e.g., not more than 3 seconds). When implementing the user interface 20 in FIG. 4B, the user would press the one physical or virtual network button 55 using a predetermined pressing sequence (e.g., not more than 3 seconds) for invoking the open mode to, for example, the guest network 15. In this example, based on the pressing sequence of the physical or virtual “guest” button 51 or the physical or virtual network button 55, the guest network SSID is changed or used as the open mode SSID.

In step S31, the gateway/access point apparatus 2 determines the received signal strength indicator (RSSI) values for all the client devices 4 from respective signals transmitted by the client devices 4. For example, the signals transmitted by each client device 4 can be a BLE beacon signal or BLE advertisement packet. The on boarding software 25 executed by the controller 26 of the gateway/access point apparatus 2 calculates the RSSI level indicating the signal strength of the signals transmitted by the respective client devices 4 (e.g., the RSSI and signal strength in decibels (dB)). The RSSI values can fluctuate. Therefore, it is contemplated by the present disclosure that an average RSSI value for each client device 4 can be used for determining the signal strength. Additionally, other criteria can be implemented such as determining the median or normal distribution of the RSSI values.

In step S32, it is determined if the determined RSSI values for each of the client devices 4 exceeds a predetermined threshold value (e.g., greater than, for example, −60 dB). In step S32, if no client device 4 has an RSSI value that exceeds the predetermined threshold value, then the gateway/access point apparatus 2 will continue to detect RSSI values until the open mode is terminated. In step S32, if any client device 4 has an RSSI value that exceeds the predetermined threshold value then, in step S33, each client device 4 having an RSSI value exceeding the predetermined threshold value will be able to connect to the guest network using the open mode SSID. For example, the gateway/access point apparatus 2 will transmit an onboard-trigger SSID to each client device having an RSSI value exceeding the predetermined threshold value, which in this example is an open mode SSID for connecting to the guest network 15. Each client device 4 receiving the open mode SSID uses it to perform an onboarding procedure for connecting to the guest network, which may include entering a network PIN.

In step S34, the gateway/access point apparatus 2 will add each client device 4 receiving the open mode SSID to a list of authorized devices for connecting to the guest network. The client devices 4 on the list can access the guest network at a later time without consideration of their respective RSSI values. In step S35, the client devices 4 added to the list are the only client devices 4 allowed to connect to the guest network after a time period (e.g., five minutes).

In the example method and algorithm of FIG. 6, the guest network SSID is used for the open mode SSID. However, it is contemplated by the present disclosure that other network SSIDs can be used for the open mode SSID. Additionally, it is contemplated by the present disclosure that a user of the mobile device 5 can invoke the open mode operations by using the mobile application 42 of the mobile device 5 via connection 10 to the gateway/access point apparatus 2.

Using the method and algorithm for implementing an open mode, allows any number of client devices 4 to join a network (e.g., guest network) at the same time. Using conventional methods or algorithms, each client device is added to a network sequentially, which could take a minute or more for each client device 4 to join the network. The method and algorithm for implementing an open mode allows any number of client devices 4 to join a network (e.g., guest network) at the same time.

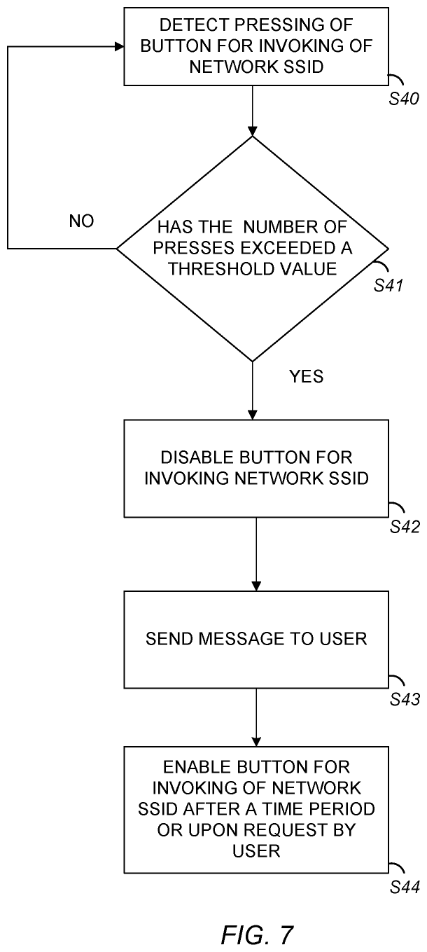

FIG. 7 illustrates a method and algorithm for providing a protection function for the wireless networks according to an embodiment of the present disclosure. The controller 26 executes one or more programs in the memory 24 of the gateway/access point apparatus 2 to perform operations for implementing the protection function.

In step S40, the controller 26 of the gateway/access point apparatus 2 detects the pressing of, for example, a physical button (e.g., any one of 50-55) of the user interface 20. The pressing can be detected using either configuration of the user interface 20 shown in FIG. 4A or 4B. In step S41, the controller 26 of the gateway/access point apparatus 2 determines if a pressing of the physical button (e.g., any one of 50-55) exceeds a predetermined threshold (e.g., 10, 20, or 30 presses in 1 minute).

In step S41, if it is determined that the detected pressing does not exceed the predetermined threshold, than the controller 26 of the gateway/access point apparatus 2 continues to detect the pressing of the physical button (e.g., any one of 50-55), as in step S40. However, in step S41, if it is determined that the detected pressing does exceed the predetermined threshold, then the controller 26 of the gateway/access point apparatus 2 disables the physical button (e.g., any one of buttons 50-55) in step S42 so that no device is able to connect to a wireless network 15-19. In steps S43, a message is displayed on the user interface 20 regarding the disabling of the physical button (e.g., any one of buttons 50-55). For example, the message can include the following information: “the xxx button was pressed too many time at 12:35 pm, and the following clients connected your gateway during that period, client 1: xxx, client 2 xxx.”

In step S44, the controller 26 of the gateway/access point apparatus 2 enables the physical button (e.g., any one of 50-55) after a predetermined time period (e.g., 10 minutes) or upon instruction of the user of the gateway/access point apparatus 2.

In the exemplary method and algorithm of FIG. 7, the protection function for the wireless networks 15-19 is performed directly from the gateway/access point apparatus 2. However, it is contemplated by the present disclosure that a user of the mobile device 5 can perform the protection function for the wireless networks 15-19 described in FIG. 7 using the mobile application 42 of the mobile device 5 via connection 10 to the gateway/access point apparatus 2. With the method and algorithm of FIG. 7, security issues associated with standard WPS are addressed by being able to disable a physical button implemented for connecting a device to a wireless network, when unauthorized use of the physical button is detected. The method and algorithm of FIG. 7 also addresses the situation in which a child presses the physical button (e.g., any one of 50-55) frequently (e.g., he/she just presses it for fun 20 times in a minute). This situation would be detected as an abnormal event requiring the disabling of the physical button (e.g., WPS button) for a period of time.

The present disclosure may be implemented as any combination of an apparatus, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIGS. 5-7. For example, the one or more memories stores software or algorithms with executable instructions and the one or more processors can execute a set of instructions of the software or algorithms in association with onboarding of wireless extenders in the wireless residential network.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

1. A method for onboarding one or more wireless devices in a wireless system, the wireless system including one or more wireless networks, a gateway/access point apparatus and one or more wireless devices, the method comprising:
selecting from a user interface of the gateway/access point apparatus, a trigger service set identifier (SSID) among a plurality of available onboarding trigger SSIDs, each onboarding trigger SSID corresponding to a different wireless network among the one or more wireless networks;
transmitting from the gateway/access point apparatus, the onboarding trigger SSID to a wireless device among the one or more wireless devices;
initiating between the wireless device and the gateway/access point apparatus, an onboarding procedure using an onboarding protocol based on the transmitted onboarding trigger SSID; and
establishing a network connection between the wireless device and a wireless network among the one or more wireless networks based on the onboarding procedure, the wireless network corresponding to the transmitted onboarding trigger SSID,
wherein the selecting, the transmitting, the initiating, and the establishing are performed for each of the one or more wireless devices for establishing a network connection to a different one of the one or more wireless networks using a corresponding onboarding trigger SSID selected from the user interface of the gateway/access point apparatus.

2. The method according to claim 1, wherein the one or more wireless networks includes a guest network, a backhaul network, a private network, an iControl network, or an IoT network.

3. The method according to claim 2, wherein the selecting of the trigger SSID includes pressing one or more physical or virtual buttons on the user interface of the gateway/access point apparatus.

4. The method according to claim 3, wherein
when the selecting of the trigger SSID includes using only one physical or virtual button, a different pressing sequence of the one physical or virtual button is used for triggering each of the corresponding onboarding trigger SSIDs, and
when the selecting of the trigger SSID includes using a plurality of physical or virtual buttons, each physical or virtual button is used for triggering a different one of the corresponding onboarding trigger SSIDs.

5. The method according to claim 4, wherein the onboarding procedure using an onboarding protocol is implemented using a wireless protected setup (WPS) procedure.

6. The method according to claim 3, further comprising:
initiating an open mode onboarding procedure by pressing the one or more buttons using a predetermined pressing sequence and triggering an open mode SSID,
wherein the open mode onboarding procedure is performed for a predetermined period of time after being initiated and for onboarding a plurality of client devices to a wireless network.

7. The method according to claim 6, wherein the open mode onboarding procedure comprises:
determining a received signal strength indicator (RSSI) from each of the one or more wireless devices;
determining if the RSSI exceeds a threshold value; and
establishing a network connection between a wireless network corresponding to the open mode SSID and any of the one or more devices with an RSSI level exceeding the threshold value.

8. The method according to claim 3, further comprising:
disabling one or more physical buttons when an unauthorized pressing sequence is detected using the one or more physical buttons, and
transmitting a message regarding the disabling of the one or more physical buttons.

9. A non-transitory computer-readable recording medium in a gateway/access point apparatus for onboarding one or more wireless devices in a wireless system, the wireless system including one or more wireless networks, the gateway/access point apparatus and the one or more wireless devices, the non-transitory computer-readable recording medium storing one or more programs which when executed by a hardware processor performs steps comprising:
selecting from a user interface of the gateway/access point apparatus, a trigger service set identifier (SSID) among a plurality of available onboarding trigger SSIDs, each onboarding trigger SSID corresponding to a different wireless network among the one or more wireless networks;
transmitting from the gateway/access point apparatus, the onboarding trigger SSID to a wireless device among the one or more wireless devices;
initiating between the wireless device and the gateway/access point apparatus, an onboarding procedure using an onboarding protocol based on the transmitted onboarding trigger SSID; and
establishing a network connection between the wireless device and a wireless network among the one or more wireless networks based on the onboarding procedure, the wireless network corresponding to the transmitted onboarding trigger SSID,
wherein the selecting, the transmitting, the initiating, and the establishing are performed for each of the one or more wireless devices for establishing a network connection to a different one of the one or more wireless networks using a corresponding onboarding trigger SSID selected from the user interface of the gateway/access point apparatus.

10. The non-transitory computer-readable recording medium according to claim 9, wherein the one or more wireless networks includes a guest network, a backhaul network, a private network, an iControl network, or an IoT network.

11. The non-transitory computer-readable recording medium according to claim 10, wherein the selecting of the trigger SSID includes pressing one or more physical or virtual buttons on the user interface of the gateway/access point apparatus.

12. The non-transitory computer-readable recording medium according to claim 11, wherein
when the selecting of the trigger SSID includes using only one physical or virtual button, a different pressing sequence of the one physical or virtual button is used for triggering each of the corresponding onboarding trigger SSIDs, and
when the selecting of the trigger SSID includes using a plurality of physical or virtual buttons, each physical or virtual button is used for triggering a different one of the corresponding onboarding trigger SSIDs.

13. The non-transitory computer-readable recording medium according to claim 9, wherein the onboarding procedure using an onboarding protocol is implemented using a wireless protected setup (WPS) procedure.

14. The non-transitory computer-readable recording medium according to claim 11, wherein the one or more onboarding programs when executed by the hardware processor performs steps further comprising:
initiating an open mode onboarding procedure by pressing the one or more buttons using a predetermined pressing sequence and triggering an open mode SSID,
wherein the open mode onboarding procedure is performed for a predetermined period of time after being initiated and for onboarding a plurality of client devices to a wireless network.

15. The non-transitory computer-readable recording medium according to claim 14, wherein the open mode onboarding procedure comprises:
determining a received signal strength indicator (RSSI) from each of the one or more wireless devices;
determining if the RSSI exceeds a threshold value; and
establishing a network connection between a wireless network corresponding to the open mode SSID and any of the one or more devices with an RSSI level exceeding the threshold value.

16. The non-transitory computer-readable recording medium according to claim 11, wherein the one or more onboarding programs when executed by the hardware processor performs steps further comprising:
disabling one or more physical buttons when an unauthorized pressing sequence is detected using the one or more physical buttons, and
transmitting a message regarding the disabling of the one or more physical buttons.

17. A gateway/access point apparatus for onboarding one or more wireless devices in a wireless system, the wireless system including one or more wireless networks, the gateway/access point apparatus and one or more wireless devices, the gateway/access point apparatus comprising:
a user interface;
a hardware processor;
a non-transitory memory storing one or more programs; and
a network interface for connecting to the one or more wireless devices,
wherein the hardware processor executes the one or more programs to:
(a) select, using the user interface, a trigger service set identifier (SSID) among a plurality of available onboarding trigger SSIDs, each onboarding trigger SSID corresponding to a different wireless network among the one or more wireless networks;
(b) transmit, using the network interface, the onboarding trigger SSID to a wireless device among the one or more wireless devices;
(c) initiate between the wireless device and the gateway/access point apparatus and using the network interface, an onboarding procedure using an on boarding protocol based on the transmitted onboarding trigger SSID; and
(d) establish a network connection between the wireless device and a wireless network among the one or more wireless networks based on the onboarding procedure, the wireless network corresponding to the transmitted onboarding trigger SSID,
wherein the (a) select, (b) transmit, (c) initiate, and (d) establish operations are performed by the gateway/access point apparatus for each of the one or more wireless devices for establishing a network connection to a different one of the one or more wireless networks using a corresponding onboarding trigger SSID selected from the user interface of the gateway/access point apparatus.

18. The apparatus according to claim 17, wherein the one or more wireless networks includes a guest network, a backhaul network, a private network, an iControl network, or an IoT network.

19. The apparatus according to claim 17, wherein the user interface includes one or more physical or virtual buttons for selecting the trigger SSID.

20. The apparatus according to claim 19, wherein the hardware processor executes the one or more programs to:
initiate an open mode onboarding procedure by pressing the one or more buttons using a predetermined pressing sequence and triggering an open mode SSID,
wherein the open mode onboarding procedure is performed for a predetermined period of time after being initiated and for onboarding a plurality of client devices to a wireless network.

21. The apparatus according to claim 20, wherein the open mode onboarding procedure:
determines a received signal strength indicator (RSSI) from each of the one or more wireless devices;
determines if the RSSI exceeds a threshold value; and
establishes a network connection between a wireless network corresponding to the open mode SSID and any of the one or more devices with an RSSI level exceeding the threshold value.

22. The apparatus according to claim 19, wherein the hardware processor executes the one or more programs to:
disable one or more physical buttons when an unauthorized pressing sequence is detected using the one or more physical buttons, and
transmit a message regarding the disabling of the one or more physical buttons.

23. A system for onboarding one or more wireless devices in a wireless system, the system comprising:
a gateway/access point apparatus including a user interface, a network interface, a hardware processor, and a non-transitory memory storing one or more programs,
one or more wireless devices, each wireless device including a hardware processor, a non-transitory memory storing one or more programs, and a network interface; and
one or more wireless networks, each wireless network being configured to establish a wireless network connection with the network interface of each of the one or more wireless devices,
wherein the respective hardware processors in the gateway/access point apparatus and the one or more wireless devices execute their respective one or more programs to cause the system to:
(a) select, using the user interface of the gateway/access point apparatus, a trigger service set identifier (SSID) among a plurality of available onboarding trigger SSIDs, each onboarding trigger SSID corresponding to a different wireless network among the one or more wireless networks;
(b) transmit, using the network interface of the gateway/access point apparatus, the onboarding trigger SSID to a wireless device among the one or more wireless devices;
(c) initiate between the network interface of the wireless device and the network interface of the gateway/access point apparatus, an onboarding procedure using an onboarding protocol based on the transmitted onboarding trigger SSID; and
(d) establish a network connection between the network interface of the wireless device and a wireless network among the one or more wireless networks based on the onboarding procedure, the wireless network corresponding to the transmitted onboarding trigger SSID,
wherein the (a) select, (b) the transmit, (c) the initiate, and (d) the establish operations are performed by the system for each of the one or more wireless devices for establishing a network connection to a different one of the one or more wireless networks using a corresponding onboarding trigger SSID selected from the user interface of the gateway/access point apparatus.

24. The system according to claim 23, wherein the one or more wireless networks includes a guest network, a backhaul network, a private network, an iControl network, or an IoT network.

25. The system according to claim 23, wherein the user interface includes one or more physical or virtual buttons on the user interface of the gateway/access point apparatus for selecting the trigger SSID.

26. The system according to claim 23, wherein the one or more wireless devices including a smartphone, tablet, digital personal assistance, hand-held wireless device, iControl device, or IoT device.
